(19) United States
(12) Patent Application Publication
(10) Pub. No.: US 2017/0371122 A1
(43) Pub. Date: Dec. 28, 2017

(54) FIBER MARKING WITH OPTICAL BRIGHTENERS

(71) Applicant: Corning Incorporated, Corning, NY (US)

(72) Inventors: Inna Igorevna Kouzmina, Corning, NY (US); Clifton Carl Roberts, Belmont, MA (US); Ruchi Tandon, Painted Post, NY (US)

(21) Appl. No.: 15/630,099

(22) Filed: Jun. 22, 2017

Related U.S. Application Data
(60) Provisional application No. 62/355,559, filed on Jun. 28, 2016.

(51) Int. Cl. G02B 6/44

(52) U.S. Cl. CPC G02B 6/4482; G02B 6/441; G02B 6/447

(57) ABSTRACT

An optical fiber having an ink layer that includes an optical brightener is described. The optical brightener is a marker that permits identification of the fiber. The ink layer may also include a pigment, where either or both of the pigment and optical brightener may function as a marker for identifying the fiber. Bundles of two or more optical fibers, each of which includes an ink layer containing an optical brightener, are also described.

This application claims the benefit of priority under 35 U.S.C. §119 of U.S. Provisional Application Ser. No. 62/355,559 filed on Jun. 28, 2016 the content of which is relied upon and incorporated herein by reference in its entirety.

### FIELD

This disclosure pertains to optical fibers. More particularly, this disclosure pertains to optical fibers configured as bundles in fibers. Most particularly this disclosure pertains to marking of fibers in bundles to facilitate identification of fibers.

### BACKGROUND

Optical fibers are widely used in the telecommunications and data transmission industries. The need for faster data transfer rates and greater bandwidth is motivating the development of new fibers with better performance characteristics. A common strategy for increasing data transmission is to bundle multiple optical fibers in a cable. To increase data transmission, it is desirable to maximize the number of optical fibers bundled in a cable. During use and installation of cables, it is often necessary to join multiple cables together to increase cable length to meet the needs of an application. Since each fiber in a bundle is dedicated to a distinct data channel, it is necessary to identify individual fibers in a bundle to insure proper connection of data channels when cables are joined.

Identification of fibers is typically accomplished by marking fibers associated with different data channels with different colors. The marking can be accomplished by applying ink layers with different colors to individual fibers to mark them. The ink layers are typically curable compositions that include color pigments. A number of colors for marking fibers has been approved as standards in the telecommunications industry. The color standards include blue, orange, green, brown, slate, white, red, black, yellow, violet, rose and aqua. Since the number of standardized colors is limited, it becomes increasingly difficult to identify individual fibers as the number of fibers in a cable increases. In principle, it is possible to increase the number of standardized colors. In practice, however, the need for unambiguous identification of fibers and possible fading or alteration of colors over time limits the number of colors available for marking fibers. There is accordingly a need for new ways to mark fibers to accommodate high fiber count cables.

### SUMMARY

An optical fiber having an ink layer that includes an optical brightener is described. The optical brightener is a marker that permits identification of the fiber. The ink layer may also include a pigment, where either or both of the pigment and optical brightener may function as a marker for identifying the fiber. Bundles of two or more optical fibers, each of which includes an ink layer containing an optical brightener, are also described as are ink layer compositions for making the ink layer. The ink layer compositions are energy curable. In embodiments, the ink layer compositions are radiation curable. Cables and ribbons containing the optical fiber or bundle of optical fibers are also disclosed.

The present description extends to:

A bundle of optical fibers comprising:

a first optical fiber, said first optical fiber including a first ink layer, said first ink layer comprising a cured product of a first ink layer composition, said first ink layer composition comprising a first concentration of a first optical brightener, said first concentration being greater than 0.5 wt %.

The present description extends to:

An optical fiber comprising an ink layer, said ink layer comprising the cured product of an ink layer composition, said ink layer composition comprising a first concentration of an optical brightener, said first concentration being greater than 1.0 wt %.

The present disclosure extends to:

An ink layer composition comprising:

a radiation-curable monomer;

a photoinitiator; and

an optical brightener, said optical brightener having a concentration greater than 1.0 wt %

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings are illustrative of selected aspects of the present description, and together with the specification serve to explain principles and operation of methods, products, and compositions embraced by the present description. Features shown in the drawing are illustrative of selected embodiments of the present description and are not necessarily depicted in proper scale.

### BRIEF DESCRIPTION OF THE DRAWINGS

While the specification concludes with claims particularly pointing out and distinctly claiming the subject matter of the written description, it is believed that the specification will be better understood from the following written description when taken in conjunction with the accompanying drawings, wherein:

FIG. 1 is a schematic view of a coated optical fiber.

FIG. 2 is a schematic view of a representative optical fiber ribbon.

FIG. 3 is a schematic view of a representative cable containing multiple optical fibers.

FIG. 4 shows thin films of illustrative cured ink layer compositions for different pigment colors and concentrations.

FIG. 5 shows thin films of illustrative cured ink layer compositions for different pigment colors and concentrations.

The embodiments set forth in the drawings are illustrative in nature and not intended to be limiting of the scope of the detailed description or claims. Whenever possible, the same reference numeral will be used throughout the drawings to refer to the same or like feature.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purpose of describing particular aspects only and is not intended to be limiting.

In this specification and in the claims which follow, reference will be made to a number of terms which shall be defined to have the following meanings:

Include,” “includes,” or like terms means encompassing but not limited to, that is, inclusive and not exclusive.

The term “about” references all terms in the range unless otherwise stated. For example, about 1, 2, or 3 is equivalent to about 1, about 2, or about 3, and further comprises from about 1-3, from about 1-2, and from about 2-3. Specific and preferred values disclosed for compositions, components, ingredients, additives, and like aspects, and ranges thereof, are for illustration only; they do not exclude other defined values or other values within defined ranges. The compositions and methods of the disclosure include those having any value or any combination of the values, specific values, more specific values, and preferred values described herein.

The indefinite article “a” or “an” and its corresponding definite article “the” as used herein means at least one, or one or more, unless specified otherwise.

As used herein, contact refers to direct contact or indirect contact. Direct contact refers to contact in the absence of an intervening material and indirect contact refers to contact through one or more intervening materials. Elements in direct contact touch each other. Elements in indirect contact do not touch each other, but do touch an intervening material or series of intervening materials, where the intervening material or at least one of the series of intervening materials touches the other. Elements in contact may be rigidly or non-rigidly joined. Contacting refers to placing two elements in direct or indirect contact. Elements in direct (indirect) contact may be said to directly (indirectly) contact each other.

As used herein, the term “curable” is intended to mean that the component, when exposed to a suitable source of curing energy, includes one or more curable functional groups capable of forming covalent bonds that participate in linking the component to itself or to other components to form a polymeric coating material (i.e., the cured product). The curing process may be induced by energy. Forms of energy include radiation or thermal energy. A radiation-curable component is a component that can be induced to undergo a curing reaction when exposed to radiation of a suitable wavelength at a suitable intensity for a sufficient period of time. The radiation curing reaction may occur in the presence of a photoinitiator. A radiation-curable component may also optionally be thermally curable. Similarly, a thermally-curable component is a component that can be induced to undergo a curing reaction when exposed to thermal energy of sufficient intensity for a sufficient period of time. A thermally curable component may also optionally be radiation curable.

A curable component may include one or more curable functional groups. A curable component with only one curable functional group may be referred to herein as a monofunctional curable component. A curable component having two or more curable functional groups may be referred to herein as a multifunctional curable component or a polyfunctional curable component. Multifunctional curable components include two or more functional groups capable of forming covalent bonds during the curing process and can introduce crosslinks into the polymeric network formed during the curing process. Multifunctional curable components may also be referred to herein as “crosslinkers” or “curable crosslinkers”. Examples of functional groups that participate in covalent bond formation during the curing process are identified hereinafter.

As used herein, the terms “non-curable” and “non-radiation curable” refer to a compound or component of a coating composition that lacks functional groups capable of forming covalent bonds when exposed to the source of curing energy (radiation, thermal) during the curing process. The term “non-reactive” refers to a compound or component of a coating composition that does not react with other components of the coating composition under the conditions used in curing the coating composition. Non-reactive compounds or components are also non-curable.

Ordering of layers in a sequence of layers in the present optical fibers will be described relative to the core of the fiber. The core corresponds to the central part of the optical fiber and forms a base upon which the cladding, coating, and ink layers are formed. Layers in contact with the core are said to “overlie” the core. When two or more layers are formed on the core, a first layer is said to overlie a second layer if the first layer is further from the core than the second layer. If a first layer overlies a second layer, the second layer may be said to “underlie” the first layer. Layers that underlie or overlie each other may be in direct or indirect contact with each other. If, for example, an optical fiber includes a core, a layer A in direct contact with the substrate, a layer B in direct contact with layer A and indirect contact with the core, and a layer C in direct contact with layer B and indirect contact with layer A and the core, each of layers A, B, and C may be said to overlie the core. Layer A may be said to underlie layers B and C. Layer B may be said to overlie layer A and underlie layer C. Layer C may be said to overlie layers A and B. Layers A and B may be said to be between the core and layer C. Layer B may be said to be between layers A and C.

As used herein, the term “on” refers to a relationship in which a layer is in contact with and overlies another layer. If, for example, an optical fiber includes a core, a layer A in direct contact with the core, and a layer B in direct contact with layer A, layers A and B may be said to be on the core and layer B may be said to be on layer A. Layer A, however, cannot be said to be on layer B.

Reference will now be made in detail to illustrative embodiments of the present description.

The present description provides marked optical fibers, methods for marking optical fibers, cables containing marked optical fibers, and coatings and coating compositions for marking optical fibers. Marking of fibers is accomplished using ink layers that include an optical brightener. An optical brightener is a luminescent compound that emits light when excited by a suitable wavelength from an excitation source. As used herein, luminescence includes fluorescence, phosphorescence, and other processes in which a compound absorbs light at one wavelength and emits light at one or more different wavelengths. The intensity and/or wavelength(s) of emission is a marker that can be used to identify the fiber.

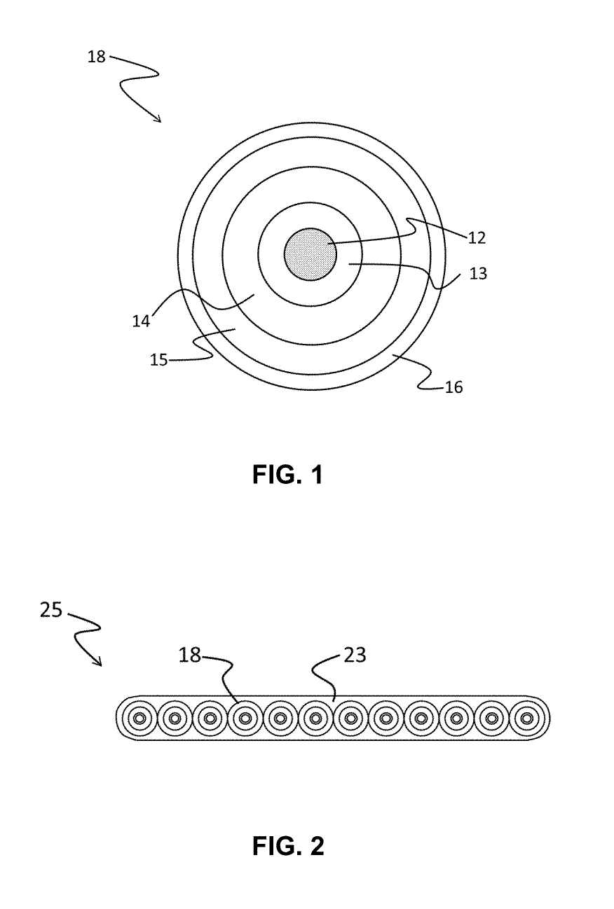

An example of a coated optical fiber is shown in schematic cross-sectional view in FIG. 1. Coated optical fiber 18 includes a glass core 12, glass cladding 13, primary coating 14, secondary coating 15, and ink layer 16. The primary coating is a soft (low modulus) coating surrounding the glass portion of the fiber and the secondary coating is a hard (high modulus) coating surrounding the primary coating. The secondary coating is mechanically rigid and allows the fiber to be handled during processing without damage to the fiber, while the primary coating dissipates external forces and prevents them from being transferred to the glass portion of the fiber so that attenuation of the optical signal caused by microbending is minimized. Although depicted as a distinct layer in FIG. 1, in certain embodiments, the ink layer may also function as a secondary coating and a separate unpigmented secondary coating may be absent. An ink layer that functions as a secondary coating may be referred to herein as a “pigmented secondary coating”. The ink layer is the cured product of a coating composition in accordance with the present description.

FIG. 2 illustrates an optical fiber ribbon 25. The ribbon 25 includes a plurality of optical fibers 18 and a matrix 23 encapsulating the plurality of optical fibers. Optical fibers 18 may include a core glass region, a cladding glass region, a primary coating, a secondary coating, and an ink layer. Alternatively, optical fibers 18 may include a core glass region, a cladding glass region, a primary coating, and a pigmented secondary coating (an ink layer that also functions as a secondary coating). The optical fibers 18 are aligned relative to one another in a substantially planar and parallel relationship. It is desirable that optical fibers 18 are not displaced from a common plane by a distance of more than about one-half the diameter thereof. The optical fibers in fiber optic ribbons may be encapsulated by the matrix 23 in any known configuration (e.g., edge-bonded ribbon, thin-encapsulated ribbon, thick-encapsulated ribbon, or multi-layer ribbon) by conventional methods of making fiber optic ribbons. In FIG. 2, the fiber optic ribbon 25 contains twelve (12) optical fibers 18; however, it should be apparent to those skilled in the art that any number of optical fibers 18 (e.g., two or more) may be employed to form fiber optic ribbon 25 disposed for a particular use.

The matrix 23 can be any suitable secondary coating composition, such those as described herein. The matrix 23 can be formed from the same composition used to prepare the secondary coating 15, or the matrix 23 can be formed from a different composition that is otherwise compatible for use. The skilled artisan will appreciate that the optical fibers 18 may include a dual-layer coating system (for example, the primary and secondary coatings described hereinabove), and may be colored with a marking ink via an ink layer or hybrid ink layer as described hereinabove.

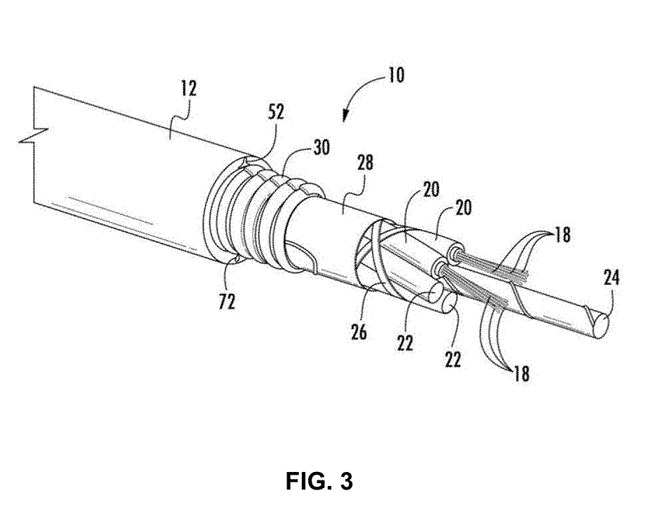

FIG. 3 depicts a representative optical communication cable. Cable 10 includes jacket 12 with buffer tubes 20 and filler rods 22 wrapped around support rod 24. Buffer tubes 20 enclose a plurality of optical fibers 18 and are wrapped by helical binders 26. Cable 10 also includes moisture barrier 28, protective tube 30, split resistant feature 52, and access feature 72. Further discussion of the features of cable 10 can be found in U.S. Pat. No. 9,140,867. Numerous other cable designs are known in the art, including designs in which ribbons of the type shown in FIG. 2 are bundled, and can be constructed with the marked fibers disclosed herein.

The ink layer is formed from an ink layer composition. In embodiments, the ink layer is the cured product of an ink layer composition. The ink layer composition is preferably a curable liquid composition or a radiation-curable liquid composition. The radiation-curable ink layer composition may include one or more radiation-curable monomers, one or more radiation-curable oligomers, one or more photoinitiators, one or more pigments, and one or more optical brighteners. The radiation-curable ink layer composition may also optionally include additives such as anti-oxidants, catalyst(s), a carrier or surfactant, a slip agent, and a stabilizer.

The one or more radiation-curable monomers may be present in the ink layer composition in an amount in the range from 10 wt %-90 wt %, or in the range from 20 wt %-80 wt %, or in the range from 30 wt %-70 wt %. The one or more radiation-curable oligomers may be present in the ink layer composition in an amount in the range from 0 wt %-90 wt %, or in the range from 10 wt %-75 wt %, or in the range from 20 wt %-60 wt %. The one or more photoinitiators may be present in the ink layer composition in an amount in the range from 0.5 wt %-20 wt %, or in the range from 1 wt %-15 wt %, or in the range from 2 wt %-10 wt %. The one or more pigments may be present in the ink layer composition in an amount in the range from 0.5 wt %-20 wt %, or in the range from 1 wt %-15 wt %, or in the range from 2 wt %-10 wt %. The one or more optical brighteners may be present in the ink layer composition in an amount in the range from 0.5 wt %-20 wt %, or in the range from 1 wt %-15 wt %, or in the range from 2 wt %-10 wt %. The ink layer composition may also include up to 25 wt % of dispersant to promote a more uniform, less aggregated distribution of the pigment.

Due to the low volatility of the components in the ink layer composition, the composition of the cured product of the ink layer composition will closely match the composition of the ink layer composition. Reactive functional groups will transform to form reaction products, but the transformations are expected to have little effect on the proportion of reactive components (or residues thereof) in the cured product.

Accordingly, the cured product of the ink layer composition may include reacted residues from one or more radiation-curable monomers in an amount in the range from 10 wt %-90 wt %, or in the range from 20 wt %-80 wt %, or in the range from 30 wt %-70 wt %. Reacted residues from the one or more radiation-curable oligomers may be present in the cured product of the ink layer composition in an amount in the range from 0 wt %-90 wt %, or in the range from 10 wt %-75 wt %, or in the range from 20 wt %-60 wt %. The reacted residue of one or more photoinitiators may be present in the cured product of the ink layer composition in an amount in the range from 0.5 wt %-20 wt %, or in the range from 1 wt %-15 wt %, or in the range from 2 wt %-10 wt %. The one or more pigments may be present in the cured product of the ink layer composition in an amount in the range from 0.5 wt %-20 wt %, or in the range from 1 wt %-15 wt %, or in the range from 2 wt %-10 wt %. The one or more optical brighteners may be present in the cured product of the ink layer composition in an amount in the range from 0.5 wt %-20 wt %, or in the range from 1 wt %-15 wt %, or in the range from 2 wt %-10 wt %. The cured product of the ink layer composition may also include up to 25 wt % of dispersant.

Preferably, the monomeric component of the ink layer composition includes ethylenically unsaturated monomer(s). While the monomeric component can be present in an amount of 50 wt % or more, it is preferably present in an amount of about 75 to about 99.2 wt %, more preferably about 80 to about 99 wt %, and most preferably about 85 to about 98 wt %.

In one embodiment, the ink layer composition includes one or more ethylenically unsaturated monomers. Ethylenically unsaturated monomers include ethylenically unsaturated groups that are radiation curable. The radiation-curable ethylenically unsaturated groups may be acrylate or methacrylate groups. As used herein, the term “(meth)acrylate” refers to acrylate, methacrylate, or a combination of acrylate and methacrylate. The ethylenically unsaturated monomers may be polyfunctional (containing two or more radiation-curable functional groups) monofunctional (containing a single radiation-curable functional group). Therefore, the ethylenically unsaturated monomer can be a polyfunctional monomer, a monofunctional monomer, or mixtures thereof. Suitable radiation-curable functional groups for ethylenically unsaturated monomers used in accordance with the present invention include, without limitation, (meth)acrylates, acrylamides, N-vinyl amides, styrenes, vinyl ethers, vinyl esters, acid esters, and combinations thereof.

Suitable polyfunctional ethylenically unsaturated monomers for the ink layer composition include, without limitation, alkoxylated bisphenol A diacrylates such as ethoxylated bisphenol A diacrylate with a degree of ethoxylation being 2 or greater, preferably ranging from 2 to about 30 (e.g. SR349 and SR601 available from Sartomer Company, Inc. (West Chester, Pa) and Photomer 4025 and Photomer 4028, available from IGM Resins Inc. (Charlotte, N.C.)), and propoxylated bisphenol A diacrylate with a degree of propoxylation being 2 or greater, preferably ranging from 2 to about 30; methylolpropane polyacrylates with and without alkoxylation such as ethoxylated trimethylolpropane triacrylate with a degree of ethoxylation being 3 or greater, preferably ranging from 3 to about 30 (e.g., Photomer 4149, (IGM Resins Inc.) and SR499 (Sartomer), propoxylated-trimethylolpropane triacrylate with a degree of propoxylation being 3 or greater, preferably ranging from 3 to 30 (e.g., Photomer 4072 (IGM Resins, Inc.) and SR492 (Sartomer)), and ditrimethylolpropane tetraacrylate (e.g., Photomer 4355 (IGM Resins, Inc.)); alkoxylated glyceryl triacrylates such as propoxylated glyceryl triacrylate with a degree of propoxylation being 3 or greater (e.g., Photomer 4096 (IGM Resins, Inc.) and SR9020 (Sartomer)); erythritol polyacrylates with and without alkoxylation, such as pentaerythritol tetraacrylate (e.g., SR295 (Sartomer), ethoxylated pentaerythritol tetraacrylate (e.g., SR494 (Sartomer), and dipentaerythritol pentaacrylate (e.g., Photomer 4399 (IGM Resins, Inc.) and SR399 (Sartomer); isocyanurate polyacrylates formed by reacting an appropriate functional isocyanurate with an acrylic acid or acryloyl chloride, such as tris-(2-hydroxyethyl) isocyanurate triacrylate (e.g., SR368 (Sartomer)) and tris-(2-hydroxyethyl) isocyanurate diacrylate; alcohol polyacrylates with and without alkoxylation such as tricyclodecane dimethanol diacrylate (e.g., CD406, (Sartomer)) and ethoxylated polyethylene glycol diacrylate with a degree of ethoxylation being 2 or greater, preferably ranging from about 2 to 30; epoxy acrylates formed by adding acrylate to bisphenol A diglycidylether (4 or more oxyethylene groups) and the like (e.g., Photomer 3016 (IGM Resins, Inc.); and single and multi-ring cyclic aromatic or non-aromatic polyacrylates such as dicyclopentadiene diacrylate and dicyclopentane diacrylate.

Exemplary monofunctional ethylenically unsaturated monomers include, without limitation, hydroxyalkyl acrylates such as 2-hydroxyethyl-acrylate, 2-hydroxypropyl-acrylate, and 2-hydroxybutyl-acrylate; long- and short-chain alkyl acrylates such as methyl acrylate, ethyl acrylate, propyl acrylate, isopropyl acrylate, butyl acrylate, amyl acrylate, isobutyl acrylate, t-butyl acrylate, pentyl acrylate, isoamyl acrylate, hexyl acrylate, heptyl acrylate, octyl acrylate, isooctyl acrylate, 2-ethylhexyl acrylate, nonyl acrylate, decyl acrylate, isodecyl acrylate, undecyl acrylate, dodecyl acrylate, lauryl acrylate, octadecyl acrylate, and stearyl acrylate; aminoalkyl acrylates such as dimethylaminoethyl acrylate, diethylaminoethyl acrylate, and 7-amino-3,7-dimethyloctyl acrylate; alkoxyalkyl acrylates such as butoxyethyl acrylate, phenoxyethyl acrylate (e.g., SR339 (Sartomer)), and ethoxyethoxyethyl acrylate; single and multi-ring cyclic aromatic or non-aromatic acrylates such as cyclohexyl acrylate, benzyl acrylate, dicyclopentadiene acrylate, dicyclopentanyl acrylate, tricyclodecanyl acrylate, bomyl acrylate, isobornyl acrylate (e.g., SR423 (Sartomer)), tetrahydrofiurfuryl acrylate (e.g., SR285 (Sartomer)), caprolactone acrylate (e.g., SR495, (Sartomer)), and acryloylmorpholine; alcohol-based acrylates such as polyethylene glycol monoacrylate, polypropylene glycol monoacrylate, methoxyethylene glycol acrylate, methoxypolypropylene glycol acrylate, methoxypolyethylene glycol acrylate, ethoxydiethylene glycol acrylate, and various alkoxylated alkylphenol acrylates such as ethoxylated(4)nonylphenol acrylate (e.g., Photomer 4003 (IGM Resins, Inc.)); acrylamides such as diacetone acrylamide, isobutoxymethyl acrylamide, N,N′-dimethyl-aminopropyl acrylamide, N,N-dimethyl acrylamide, N,N diethyl acrylamide, and t-octyl acrylamide; vinylic compounds such as N-vinylpyrrolidone and N-vinylcaprolactam; and acid esters such as maleic acid ester and fumaric acid ester. With respect to the long and short chain alkyl acrylates listed above, a short chain alkyl acrylate is an alkyl group with 6 or less carbons and a long chain alkyl acrylate is alkyl group with 7 or more carbons.

Most suitable monomers are commercially available (suppliers for selected compounds noted above) or readily synthesized using reaction schemes known in the art. Many monomers can be formed, for examples, from reactions between an appropriate (di)alcohol or (di)amine with (meth)acrylic acid or (meth)acryloyl chloride.

The ink layer composition may exclude radiation-curable oligomers or the ink layer composition may include an oligomeric component with one or more radiation-curable oligomers. The one or more oligomers may include one or more monofunctional oligomers, one or more polyfunctional oligomers, or a combination thereof. Preferable oligomer(s) includes ethylenically unsaturated oligomer(s), such as aliphatic and aromatic urethane (meth)acrylate oligomers, urea (meth)acrylate oligomers, polyester and polyether (meth)acrylate oligomers, acrylated acrylic oligomers, polybutadiene (meth)acrylate oligomers, polycarbonate (meth)acrylate oligomers, and melamine (meth)acrylate oligomers.

The oligomeric component the secondary composition may include a difunctional oligomer. A difunctional oligomer may have a structure according to formula (I) below:

F₁—R₁-[diisocyanate-R₂-diisocyanate]ₘR₁—F₁ (I)

where F₁ may independently be a reactive functional group such as acrylate, methacrylate, acrylamide, N-vinyl amide, styrene, vinyl ether, vinyl ester, or other functional group known in the art; R₁ may include, independently, —C₂₋₁₂ O—, —(C₂₋₄ —O)ₙ—, —C₂₋₁₂ O—(C₂₋₄ —O)ₙ—, —C₂₋₁₂ O—(CO—C₂₋₅ O)ₙ—, or —C₂₋₁₂ O—(CO—C₂₋₅ NH)ₙ— where n is a whole number from 1 to 30, including, for example, from 1 to 10; R₂ may be a polyether, polyester, polycarbonate, polyamide, polyurethane, polyurea, or combination thereof; and m is a whole number from 1 to 10, including, for example, from 1 to 5. In the structure of formula (I), the diisocyanate moiety may be the residue formed from the reaction of a diisocyanate with R₂ and/or R₁. The term “independently” is used herein to indicate that each F₁ may differ from another F₁ and the same is true for each R₁.

The oligomer component of the curable ink layer composition may include a polyfunctional oligomer. The polyfunctional oligomer may have a structure according to formula (II), formula (III), or formula (IV) set forth below:

multiisocyanate-(F₂—R₁—F₂)ₓ (II)

polyol-[(diisocyanate-R₂-diisocyanate)ₘ-R₁—F₂]ₓ (III)

multiisocyanate-(R₁—F₂)ₓ (IV)

where F₂ may independently represent from 1 to 3 functional groups such as acrylate, methacrylate, acrylamide, N-vinyl amide, styrene, vinyl ether, vinyl ester, or other functional groups known in the art; R₁ can include —C₂₋₁₂ O—, —(C₂₋₄ —O)ₙ—, —C₂₋₁₂ O—(C₂₋₄ —O)ₙ—, —C₂₋₁₂ O—(CO—C₂₋₅ O)ₙ—, or —C₂₋₁₂ O—(CO—C₂₋₅ NH)ₙ— where n is a whole number from 1 to 10, including, for example, from 1 to 5; R₂ may be polyether, polyester, polycarbonate, polyamide, polyurethane, polyurea or combinations thereof; x is a whole number from 1 to 10, including, for example, from 2 to 5; and m is a whole number from 1 to 10, including, for example, from 1 to 5. In the structure of formula (II), the multiisocyanate group may be the residue formed from reaction of a multiisocyanate with R₂. Similarly, the diisocyanate group in the structure of formula (III) may be the reaction product formed following bonding of a diisocyanate to R₂ and/or R₁.

Urethane oligomers may be prepared by reacting an aliphatic or aromatic diisocyanate with a dihydric polyether or polyester, most typically a polyoxyalkylene glycol such as a polyethylene glycol. Moisture-resistant oligomers may be synthesized in an analogous manner, except that polar polyethers or polyester glycols are avoided in favor of predominantly saturated and predominantly nonpolar aliphatic diols. These diols may include alkane or alkylene diols of from about 2-250 carbon atoms that may be substantially free of ether or ester groups.

Polyurea elements may be incorporated in oligomers prepared by these methods, for example, by substituting diamines or polyamines for diols or polyols in the course of synthesis. The presence of minor proportions of polyureas in the secondary coating composition is not considered detrimental to ink layer performance, provided that the diamines or polyamines employed in the synthesis are sufficiently non-polar and saturated as to avoid compromising the moisture resistance of the system.

The ink layer composition includes a polymerization initiator. The polymerization initiator is a reagent that is suitable to cause polymerization (i.e., curing) of the composition. Curing of the composition induces a transition of the ink layer composition from a viscous liquid state to a solid state. Polymerization initiators suitable for use in the ink layer composition include thermal initiators, chemical initiators, electron beam initiators, and photoinitiators. Photoinitiators are the preferred polymerization initiators. For most (meth)acrylate-based coating formulations, conventional photoinitiators, such as the known ketonic photoinitiators and/or phosphine oxide photoinitiators, are preferred. Photoinitiators are reactive components and undergo reaction, rearrangement, or decomposition to provide chemical species (e.g. free radicals) capable of initiating a photoreaction with a curable component of the ink layer composition. Activation of a photoinitiator to provide reactive species for photopolymerization of radiation-curable components of the ink layer composition is accomplished by exposing the photoinitiator to a suitable wavelength of radiation. In preferred embodiments, the photoinitiator is activated by UV radiation and the ink layer composition is a UV-curable composition.

Suitable photoinitiators include, without limitation, 1-hydroxycyclohexyl-phenyl ketone (e.g. Irgacure 184 available from BASF), (2,6-dimethoxybenzoyl)-2,4,4-trimethylpentyl phosphine oxide; commercial blends of (2,6-dimethoxybenzoyl)-2,4,4-trimethylpentyl phosphine oxide with Irgacure 184 (e.g. Irgacure 1800, 1850, 1870, and 1700 available from BASF), 2,2-dimethoxyl-2-phenyl acetophenone (e.g. Irgacure 651, available from BASF), bis(2,4,6-trimethyl benzoyl)phenyl-phosphine oxide (e.g. Irgacure 819, available from BASF), (2,4,6-trimethylbenzoyl)diphenyl phosphine oxide (e.g. Lucirin TPO available from BASF), ethoxy(2,4,6-trimethylbenzoyl)phenyl phosphine oxide (e.g. Lucirin TPO-L from BASF), and combinations thereof.

Pigments of various colors are known in the art and are available from commercial sources. The pigments used herein were energy curable dispersions of colored particles obtained from Penn Color (Doylestown, Pa.). The energy curable dispersions are curable upon excitation of light of a suitable wavelength. The excitation wavelength is preferable a UV wavelength. Specific formulations for the energy curable dispersions are proprietary to the manufacturer, but the dispersions generally included a suspension of colored particles in a curable liquid suspension medium. Particles diameters were kept at 1 micron or less to promote uniformity of dispersion and minimize aggregation. The colored particles were based on TiO₂. The curable liquid suspension medium included one or more proprietary acrylate and/or acrylate derivative compounds, and a proprietary curing agent. Other compounds in the curable liquid suspension medium may include propoxylated neopentyl glycol diacrylate, vinyl caprolactam, and/or butyl benzyl phthalate. Specific product numbers for different colors will be noted in the Examples described hereinbelow.

The ink layer composition includes one or more optical brighteners. An optical brightener is a luminescent compound. An optical brightener absorbs light and then emits light, where the emitted light occurs at longer wavelength than the absorbed light. An optical brightener can be selected from a number of known luminescent compounds. Representative optical brighteners include derivatives of benzoxazole compounds (e.g. Hostalux® KCB (from Clariant of Muttenz, Switzerland), or Hostalux® KCU (from Clariant)); thiophenediyl) bis[5-tert-butylbenzoxazole](e.g. Benetex® OB from Mayzo, Inc. (Suwanee, Ga.)); 4,4′-bis(2-benzoxazolyl) stilbene (e.g. Eastobrite® OB-1 from Eastman Chemical (Kingsport, Tenn.)); derivatives of 4,4′-diminostilbene-2-2′disulfonic acid, 4-methyl-7-diethylaminocoumarin, Uvitex OB (2,5-thiophenediylbis(5-tert-butyl-1,3-benzoxazole) (BASF)); Blankophor KLA (Bayer); bisbenzoxazole compounds; phenylcoumarin compounds; and bis(styryl)biphenyl compounds.

Optical brighteners include compounds that absorb light at wavelengths less than 450 nm, or wavelengths less than 425 nm, or wavelengths less than 400 nm, or wavelengths less than 375 nm, or wavelengths less than 350 nm and that emit light at wavelengths greater than the wavelength of absorbed light. For any of the absorbed wavelengths of light noted above, the emitted light may occur at a wavelength less than 650 nm, or less than 600 nm, or less than 550 nm, or less than 500 nm.

When configured as a standalone layer, the thickness of the ink layer after curing may be in the range from 0.5 μm-20 μm, or in the range from 1 μm-10 μm, or in the range from 2 μm-8 μm. When configured as a pigmented secondary coating, the thickness of the ink layer after curing may be in the range from 10 μm-50 μm, or in the range from 15 μm-45 μm, or in the range from 20 μm-40 μm.

The optical brightener can be included in ink layers having pigments of any color, including ink layers lacking a pigment. The presence of the optical brightener provides a marker useful for identifying optical fibers in addition to color. In preferred embodiments, the presence of an optical brightener in the ink layer does not alter the color of the ink layer as viewed by the naked eye and the color of the ink layer is determined by the color, type, and concentration of pigment in the ink layer. When excited by light of an appropriate wavelength, however, the optical brightener emits light that can be detected (by the eye or with light-detecting instrumentation) and used to identify a fiber.

The present description encompasses an optical fiber with an ink layer that includes an optical brightener. The concentration of optical brightener in the ink layer composition used to form the ink layer of an optical fiber may be greater than 0.25 wt %, or greater than 0.5 wt %, or greater than 1.0 wt %, or greater than 1.5 wt %, or greater than 2.0 wt %, or greater than 3.0 wt %, or greater than 4.0 wt %, or greater than 5.0 wt %, or greater than 7.0 wt %, or in the range from 0.25 wt %-20 wt %, or in the range from 0.5 wt %-20 wt %, or in the range from 1.0 wt %-20 wt %, or in the range from 2.0 wt %-15 wt %, or in the range from 2.0 wt %-10 wt %, or in the range from 2.0 wt %-8.0 wt %. The ink layer of the optical fiber may include two or more optical brighteners, where the concentration of each optical brightener in the ink layer composition used to form the ink layer or the combined concentration of all optical brighteners in the ink layer composition used to form the ink layer are within the ranges stated above. Each of two or more optical brighteners may be supplied in a separate ink layer composition or two or more optical brighteners may be combined and included in a single ink layer composition.

The present description encompasses bundles of optical fibers that include ink layers with different optical brighteners or different concentrations of the same optical brightener. Bundles of optical fibers are fiber assemblies that include a combination of two or more optical fibers. Fiber bundles may be incorporated in cables.

By varying the concentration of optical brightener in the ink layer, the intensity of luminescence can be varied. Either or both of the wavelength(s) and intensity of light emitted by the optical brightener(s) may be used to identify and distinguish different optical fibers in a bundle or cable. The two or more optical fibers may include fibers colored by the same or different pigment. A combination of optical fibers, for example, may contain two fibers with blue pigment, where each of the fibers includes an ink layer with an optical brightener and where the optical brighteners are the same or different compound or the same compound in different concentrations. The combination of optical fibers may include one or more fibers with ink layers containing an optical brightener and one or more fibers with ink layers lacking an optical brightener. Fibers with ink layers lacking an optical brightener are distinguishable because they lack the luminescence observed from fibers with ink layers containing an optical brightener. Absence of the luminescence signal serves as a marker of fibers with ink layers lacking an optical brightener.

The concentration of optical brightener in the ink layer composition used to form the ink layer of each of two or more optical fibers in a bundle may, independently, be greater than 0.25 wt %, or greater than 0.5 wt %, or greater than 1 wt %, or greater than 1.5 wt %, or greater than 2 wt %, or greater than 3 wt %, or greater than 4 wt %, or greater than 5.0 wt %, or greater than 7.0 wt %, or in the range from 0.25 wt %-20 wt %, or in the range from 0.5 wt %-20 wt %, or in the range from 0.5 wt %-15 wt %, or in the range from 1.0 wt %-20 wt %, or in the range from 1.0 wt %-10 wt %, or in the range from 2.0 wt %-8.0 wt %.

In addition to one or more optical fibers with ink layers having optical brightener(s) at concentrations noted above, the bundle of optical fibers may also include one or more fibers with an ink layer that lacks an optical brightener and/or one or more fibers with an ink layer that includes an optical brightener at a concentration greater than 0% and less than 0.5 wt %, or at a concentration greater than 0% and less than 0.4 wt %, or at a concentration greater than 0% and less than 0.3 wt %, or at a concentration greater than 0% and less than 0.2 wt %, or at a concentration greater than 0% and less than 0.1 wt %.

In addition to the base components (one or more radiation-curable monomers, one or more radiation-curable oligomers, one or more photoinitiators, one or more pigments, and one or more optical brighteners), the ink layer composition may also include one or more additives. The one or more additives are optional and may include an adhesion promoter, an antioxidant, a catalyst, a carrier or surfactant, a tackifier, a stabilizer, or a slip agent. Some additives (e.g., catalysts, reactive surfactants) may operate to control the polymerization process and may thereby affect the physical properties (e.g., modulus, glass transition temperature) of the cured product formed from the coating composition. Other additives may influence the integrity of the cured product of the coating composition (e.g., protection against UV-induced curing or oxidative degradation).

An adhesion promoter enhances the adhesion of the ink layer to the underlying secondary coating or primary coating. Examples of a suitable adhesion promoter include, without limitation, organofunctional silanes, titanates, zirconates, and mixtures thereof. One preferred class are the poly(alkoxy)silanes. Suitable alternative adhesion promoters include, without limitation, bis(trimethoxysilylethyl)benzene, 3-mercaptopropyltrimethoxy-silane (3-MPTMS, available from United Chemical Technologies, Bristol, Pa.; also available from Gelest, Morrisville, Pa.), 3-acryloxypropyltrimethoxysilane (available from Gelest), and 3-methacryloxypropyltrimethoxysilane (available from Gelest), and bis(trimethoxysilylethyl)benzene (available from Gelest). Other suitable adhesion promoters are described in U.S. Pat. Nos. 4,921,880 and 5,188,864 to Lee et al., each of which is hereby incorporated by reference. The adhesion promoter, if present, is used in an amount between about 0.1 pph to about 10 pph, more preferably about 0.25 pph to about 3 pph.

Antioxidants provide stability of the ink layer to oxidation. Preferred antioxidants include, without limitation, bis hindered phenolic sulfide or thiodiethylene bis(3,5-di-tert-butyl)-4-hydroxyhydrocinnamate (e.g. Irganox 1035 (BASF)), 2,6-di-t-butyl-4-methylphenol (BHT), MEHQ (monomethyl ether hydroquinone), and octadecyl-3-(3,5-di-tertbutyl-4-hydroxyphenyl)propionate (e.g. Irganox 1076 (BASF)). The antioxidant, if present, is used in an amount between about 0.1 pph to about 3 pph, more preferably about 0.25 pph to about 2 pph.

An exemplary catalyst is a tin catalyst, such as dibutyltin dilaurate, which is used to catalyze the formation of urethane bonds in some non-radiation curable components. Whether the catalyst remains as an additive of the non-radiation curable component or additional quantities of the catalyst are introduced into the composition, the presence of the catalyst may act to stabilize the non-radiation curable component(s) in the composition. Any tendency of excess tin catalyst to destabilize the silane adhesion promoter can be counteracted by addition of tetrathiol.

One preferred stabilizer is a tetrafunctional thiol, e.g., pentaerythritol tetrakis(3-mercaptopropionate) from Sigma-Aldrich (St. Louis, Mo.). The stabilizer, if present, is used in an amount between about 0.01 pph to about 1 pph, more preferably about 0.01 pph to about 0.2 pph.

Slip agents enhance wetting and flow of the ink layer composition. Slip agents include silicone polyether acrylate compounds (e.g. Tego® Rad 2250, Tego® Rad 2200, Tego® Rad 2700, Tego® Glide 432, Tego® Glide 435 (Evonik Industries). Other classes of slip agents include polyols and non-reactive surfactants such as, without limitation, the polyol Acclaim 3201 (poly(ethylene oxide-co-propylene oxide)) available from Bayer (Newtown Square, Pa.).

The present description encompasses ribbons or cables for optical communications that include two or more fibers as described herein. The ribbons or cables may be incorporated within or interface with a telecommunications system. The telecommunication system may include a transmitter, an optical communication channel coupled to the transmitter, and a receiver coupled to the optical communication channel. The transmitter includes a light source for generating an optical signal and launching the optical signal into the optical communication channel. The optical signal propagates through the optical communication channel and is directed to the receiver. The receiver detects and/or processes the optical signal. The optical signal embodies data or information. The transmitter may also encode the data or information in the form of an optical signal and the receiver may decode the optical signal to recover the data or information. The transmitter may also encrypt the data or information in the optical signal and the receiver may also decrypt the optical signal when restoring the data or information. The optical communication channel includes an optical fiber or combination of two or more optical fibers as described herein.

### EXAMPLES

A series of ink layer compositions was formulated and cured to form film samples. The components of the ink layer compositions are summarized in Tables 1 and 2 below.

TABLE 1

| Component | White | Black | Slate | Blue | Aqua | Yellow |
|---|---|---|---|---|---|---|
| Photomer 3016 | 30.0 | 30.0 | 30.0 | 30.0 | 30.0 | 30.0 |
| Photomer 4028 | 53.33 | 55 | 52.33 | 52 | 52.33 | 54.25 |
| NVC | 5.0 | 5.0 | 5.0 | 5.0 | 5.0 | 5.0 |
| TPO | 1.5 | 1.5 | 1.5 | 1.5 | 1.5 | 1.5 |
| Irgacure 184 | 1.5 | 1.5 | 1.5 | 1.5 | 1.5 | 1.5 |
| Benetex ® OB | 2.0 | 2.0 | 2.0 | 2.0 | 2.0 | 2.0 |
| Irganox 1076 | 0.5 | 0.5 | 0.5 | 0.5 | 0.5 | 0.5 |
| Tegorad 2250 | 3.25 | 3.25 | 3.25 | 3.25 | 3.25 | 3.25 |
| White Dispersion | 6.67 | 0 | 6.67 | 2.0 | 6.67 | 2.5 |
| Black Dispersion | 0 | 5.0 | 1.0 | 0 | 0 | 0 |
| Blue Dispersion | 0 | 0 | 0 | 6.0 | 0.4 | 0 |
| Yellow Dispersion | 0 | 0 | 0 | 0 | 0 | 3.25 |
| Green Dispersion | 0 | 0 | 0 | 0.6 | 0 | 0 |
| Red Dispersion | 0 | 0 | 0 | 0 | 0 | 0 |
| Violet Dispersion | 0 | 0 | 0 | 0 | 0 | 0 |
| Orange Dispersion | 0 | 0 | 0 | 0 | 0 | 0 |

TABLE 2

| Component | Green | Red | Rose | Violet | Orange | Brown |
|---|---|---|---|---|---|---|
| Photomer 3016 | 30.0 | 30.0 | 30.0 | 30.0 | 30.0 | 30.0 |
| Photomer 4028 | 53.0 | 54.35 | 52.5 | 54.75 | 53.0 | 50.5 |
| NVC | 5.0 | 5.0 | 5.0 | 5.0 | 5.0 | 5.0 |
| TPO | 1.5 | 1.5 | 1.5 | 1.5 | 1.5 | 1.5 |
| Irgacure 184 | 1.5 | 1.5 | 1.5 | 1.5 | 1.5 | 1.5 |
| Benetex ® OB | 6.0 | 6.0 | 6.0 | 6.0 | 6.0 | 6.0 |
| Irganox 1076 | 0.5 | 0.5 | 0.5 | 0.5 | 0.5 | 0.5 |
| Tegorad 2250 | 3.25 | 3.25 | 3.25 | 3.25 | 3.25 | 3.25 |
| White Dispersion | 2.0 | 1.0 | 6.67 | 3.5 | 2.0 | 1.5 |
| Black Dispersion | 0 | 0 | 0 | 0 | 0 | 0 |
| Blue Dispersion | 0 | 0.15 | 0 | 0 | 0 | 0 |
| Yellow | 1.0 | 0 | 0 | 0 | 0 | 0 |
| Dispersion | | | | | | |
| Green Dispersion | 4.0 | 0 | 0 | 0 | 0 | 0 |
| Red Dispersion | 0 | 4.5 | 0.83 | 0 | 0 | 0 |
| Violet | 0 | 0 | 0 | 1.75 | 0 | 2.0 |
| Dispersion | | | | | | |
| Orange | 0 | 0 | 0 | 0 | 5.0 | 6.0 |
| Dispersion | | | | | | |

Photomer 3016 (an oligomer) is bisphenol A epoxy diacrylate (IGM Resins), Photomer 4028 (a monomer) is ethoxylated(4) bisphenol A diacrylate (IGM Resins), NVC (a monomer) is N-vinylcaprolactam (Aldrich), TPO (a photoinitiator) is 2,4,6-trimethylbenzoyl diphenylphosphine oxide (BASF), Irgacure 184 (a photoinitiator) is 1-hydroxycyclohexyl-phenyl ketone (BASF), Benetex® OB (an optical brightener) is 2,2′-(2,5-thiophenediyl) bis[5-tert-butylbenzoxazole] (Mayzo), Irganox 1076 (an antioxidant) is octadecyl-3-(3,5-di-tertbutyl-4-hydroxyphenyl)propionate (BASF), Tegorad 2250 (a slip agent) is a silicone polyether acrylate compound (Evonik Industries).

The balance of the ink layer compositions consisted of pigment dispersions having the colors listed in Tables 1 and 2. All pigment dispersions were obtained from Penn Color, Inc. (Doylestown, Pa.). The product numbers for the dispersions are as follows: white dispersion (9W892), black dispersion (9B385), blue dispersion (9S959D), yellow dispersion (9Y1107), green dispersion (9G944D), red dispersion (9R925), violet dispersion (9S949D), and orange dispersion (9Y804).

The ink compositions were prepared by mixing all components except for the pigment dispersion at 65° C. in a jacketed beaker. Mixing was continued until all solid components were dissolved and a homogeneous mixture was obtained. The homogeneous mixture was filtered to a level of 1 μm absolute. The required amount of pigment dispersion(s) was added to the filtered mixture and blended with a high speed mixer for approximately 30 minutes to obtain the ink layer composition.

Films from the ink layer compositions were formed on glass plates using the following procedure. Wet films were cast on glass plates with the aid of a draw-down box having an about 0.005″ gap thickness. Films were cured with 1.2 J/cm² UV dose (measured over a wavelength range of 225-424 nm by a Light Bug model IL490 from International Light) by a Fusion Systems UV curing apparatus with a 600 W/in D-bulb (50% Power and approximately 12 ft/min belt speed) to yield ink layers in film form. Cured film thickness was between about 0.003″ and 0.004″.

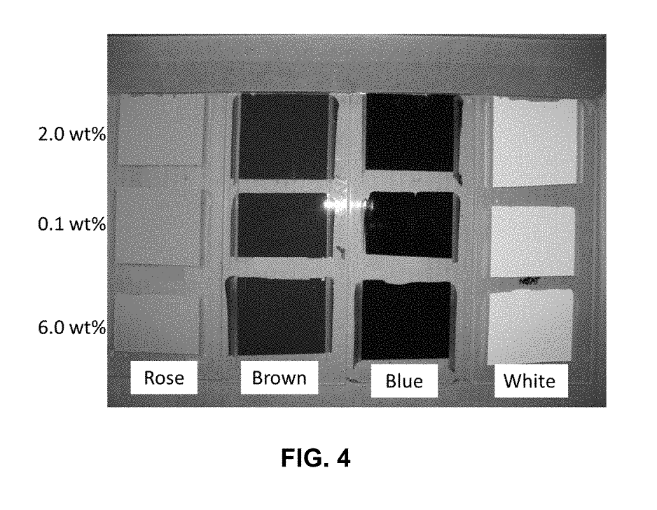

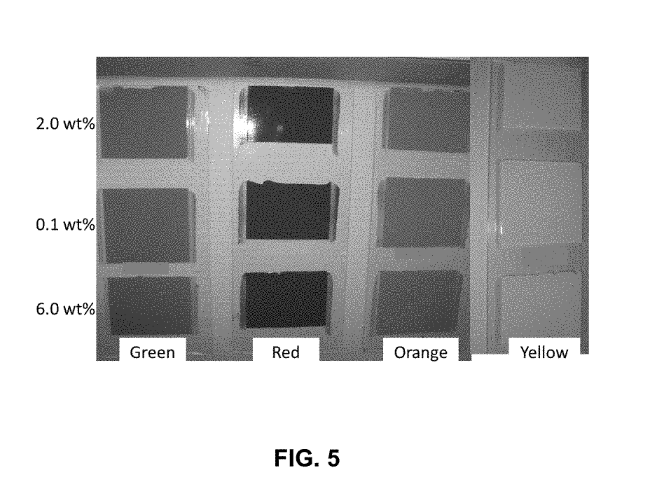

FIGS. 4 and 5 are grayscale images showing thin films of eight different ink layer compositions after curing. Images for ink layers based on eight pigment colors are shown (rose, brown, blue, white, green, red, orange, and yellow). For each pigment color, films for three different concentrations (0.1 wt %, 2.0 wt %, and 6.0 wt %) of the optical brightener in the ink layer composition are shown. Columns of the sample images are labeled by pigment color and rows are labeled by optical brightener concentration in the ink layer composition.

When the films were subjected to UV light from a black light source in the dark, luminescence was observed by eye from each of the films. The intensity of luminescence correlated with the concentration of optical brightener included in the ink layer composition. For all pigment colors, fluorescence intensity increased with increasing concentration of optical brightener in the ink layer composition. The results indicate that variations in the concentration of optical brightener in the ink layer composition (and ink layer formed by curing the ink layer composition) provide an effective marker for distinguishing optical fibers on the basis of the intensity of light emitted from an optical brightener in the ink layer.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the illustrated embodiments. Since modifications, combinations, sub-combinations and variations of the disclosed embodiments that incorporate the spirit and substance of the illustrated embodiments may occur to persons skilled in the art, the description should be construed to include everything within the scope of the appended claims and their equivalents.

What is claimed is:

1. A bundle of optical fibers comprising:
a first optical fiber, said first optical fiber including a first ink layer, said first ink layer comprising a cured product of a first ink layer composition, said first ink layer composition comprising a first concentration of a first optical brightener, said first concentration being greater than 0.5 wt %.

2. The bundle of claim 1, further comprising:
a second optical fiber, said second optical fiber including a second ink layer, said second ink layer comprising a cured product of a second ink layer composition, said second ink layer composition comprising a second concentration of a second optical brightener, said second concentration being greater than 0 wt %.

3. The bundle of claim 2, wherein said first ink layer further comprises a first pigment.

4. The bundle of claim 3, wherein said first pigment comprises TiO₂.

5. The bundle of claim 1, wherein said first concentration is greater than 2.0 wt %.

6. The bundle of claim 2, wherein said second concentration is less than 0.4 wt %.

7. The bundle of claim 6, wherein said first concentration is greater than 2.0 wt %.

8. The bundle of claim 3, wherein said second ink layer further comprises a second pigment.

9. The bundle of claim 8, wherein said first concentration differs from said second concentration.

10. The bundle of claim 2, wherein said second optical brightener is the same as said first optical brightener.

11. The bundle of claim 10, wherein said first concentration differs from said second concentration.

12. The bundle of claim 1, wherein said first ink layer composition comprises a radiation-curable monomer.

13. The bundle of claim 2, further comprising a third optical fiber, said third optical fiber including a third ink layer, said third ink layer comprising a cured product of a third ink layer composition, said third ink layer composition comprising a third concentration of a third optical brightener, said third concentration being greater than 0 wt %.

14. The bundle of claim 13, wherein said third concentration is greater than 0.5 wt % and said second concentration is less than 0.5 wt %.

15. The bundle of claim 14, wherein said first concentration is greater than 1.0 wt % and said third concentration is greater than 1.0 wt %.

16. A cable or ribbon comprising the bundle of claim 1.

17. An optical fiber comprising an ink layer, said ink layer comprising the cured product of an ink layer composition, said ink layer composition comprising a first concentration of an optical brightener, said first concentration being greater than 1.0 wt %.

18. The optical fiber of claim 17, wherein said ink layer composition further comprises a pigment.

19. An ink layer composition comprising:
a radiation-curable monomer;
a photoinitiator; and
an optical brightener, said optical brightener having a concentration greater than 1.0 wt %.

20. The cured product of the ink layer composition of claim 19.
